(19) United States
(12) Patent Application Publication
(10) Pub. No.: US 2025/0095905 A1
(43) Pub. Date: Mar. 20, 2025

(54) COIL COMPONENT

(71) Applicant: SAMSUNG ELECTRO-MECHANICS CO., LTD., Suwon-si (KR)

(72) Inventors: Sang Jin KIM, Suwon-si (KR); Boum Seock KIM, Suwon-si (KR); Byeong Cheol MOON, Suwon-si (KR); Ju Hwan YANG, Suwon-si (KR); Han LEE, Suwon-si (KR)

(73) Assignee: SAMSUNG ELECTRO-MECHANICS CO., LTD., Suwon-si (KR)

(21) Appl. No.: 18/794,151

(22) Filed: Aug. 5, 2024

(30) Foreign Application Priority Data
Sep. 18, 2023 (KR) 10-2023-0123907

(51) Int. Cl. H01F 27/28; H01F 27/02; H01F 27/29

(52) U.S. Cl. CPC H01F 27/2804; H01F 27/022; H01F 27/2828; H01F 27/29; H01F 2027/2809

(57) ABSTRACT

A coil component includes a coil component includes a body including a first surface and a second surface opposing each other in a first direction; a coil disposed in the body and including a plurality of coil layers; an insulating layer disposed in each of regions between the plurality of coil layers; an external electrode disposed on the first surface of the body; and a connection portion disposed in the body, connecting one of the plurality of coil layers to the external electrode, and having one surface in contact with the one of the plurality of coil layers and the other surface in contact with the external electrode. The connection portion includes a fusion portion disposed on an end thereof to be in contact with the one of the plurality of coil layers.

### CROSS-REFERENCE TO RELATED APPLICATION(S)

This application claims benefit of priority to Korean Patent Application No. 10-2023-0123907 filed on Sep. 18, 2023 in the Korean Intellectual Property Office, the disclosure of which is incorporated herein by reference in its entirety.

### TECHNICAL FIELD

The present disclosure relates to a coil component.

### BACKGROUND

An inductor, a coil component, may be a representative passive electronic component used in an electronic device along with a resistor and a capacitor.

As an electronic device has been designed to have high-performance and a reduced size, the number of electronic components used in an electronic device has increased and a size thereof has been reduced.

In a coil component disposed in a limited mounting area in a circuit board, a multilayer coil structure may be advantageous to increase the number of turns of a coil, and there has been demand for a coil component having the multilayer coil structure and ensuring a magnetic volume.

### SUMMARY

An aspect of the present disclosure is to increase the number of turns of a coil within a limited size through a multilayer coil structure from which a support substrate is removed.

Another aspect of the present disclosure is to, by maximizing an effective volume in a coil component having a limited size through a structure in which a coil and an external electrode are connected to each other in a body, improve inductance properties and saturation current Iₛₐₜ properties.

According to an aspect of the present disclosure, a coil component includes a body including a first surface and a second surface opposing each other in a first direction; a coil disposed in the body and including a plurality of coil layers; an insulating layer disposed in each of regions between the plurality of coil layers; an external electrode disposed on the first surface of the body; and a connection portion disposed in the body, connecting one of the plurality of coil layers to the external electrode, and having one surface in contact with the one of the plurality of coil layers and the other surface in contact with the external electrode. The connection portion includes a fusion portion disposed on an end thereof to be in contact with the one of the plurality of coil layers.

### BRIEF DESCRIPTION OF DRAWINGS

The above and other aspects, features, and advantages of the present disclosure will be more clearly understood from the following detailed description, taken in conjunction with the accompanying lead-outs, in which:

FIG. 1 is a perspective diagram illustrating a coil component according to a first embodiment of the present disclosure;

FIG. 2 is an exploded perspective diagram illustrating the example illustrated in FIG. 1;

FIG. 3 is a cross-sectional diagram taken along line I-I′ in FIG. 1;

FIG. 4 is an enlarged diagram illustrating region A in FIG. 3;

FIG. 5 is a cross-sectional diagram taken along line II-II′ in FIG. 1;

FIG. 6 is a diagram illustrating a coil component according to a second embodiment of the present disclosure, corresponding to FIG. 3; and

FIGS. 7 to 10 are a diagram illustrating a process of manufacturing a coil component according to a first embodiment of the present disclosure.

### DETAILED DESCRIPTION

Hereinafter, embodiments of the present disclosure will be described as follows with reference to the attached drawings.

The present disclosure may, however, be exemplified in many different forms and should not be construed as being limited to the specific embodiments set forth herein. An expression used in the singular encompasses the expression of the plural, unless it has a clearly different meaning in the context. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof. Also, the expression that an element is disposed “On” may indicate that the element may be disposed above or below a target portion, and does not necessarily indicate the element is disposed above the target portion in the direction of gravity.

It will be understood that when an element is “coupled with/to” or “connected with” another element, the element may be directly coupled with/to another element, and there may be an intervening element between the element and another element. To the contrary, it will be understood that when an element is “directly coupled with/to” or “directly connected to” another element, there is no intervening element between the element and another element.

The structures, shapes, and sizes described as examples in embodiments in the present disclosure may be implemented in another exemplary embodiment without departing from the spirit and scope of the present disclosure.

In the drawings, the T direction may be defined as a first direction or a thickness direction, the L direction may be defined as a second direction or a length direction, and the W direction may be defined as a third direction or a width direction.

In the drawings, the same elements will be indicated by the same reference numerals. Also, redundant descriptions and detailed descriptions of known functions and elements which may unnecessarily make the gist of the present disclosure obscure will not be provided.

Various types of electronic components are used in electronic devices, and various types of coil components may be appropriately used between these electronic components for the purpose of removing noise.

That is, in electronic devices, a coil component may be used as a power inductor, a HF inductor, a general bead, a GHz bead, a common mode filter, or the like.

### First Embodiment

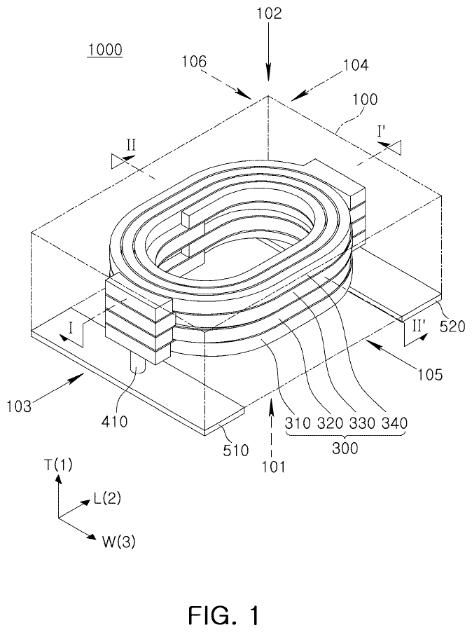

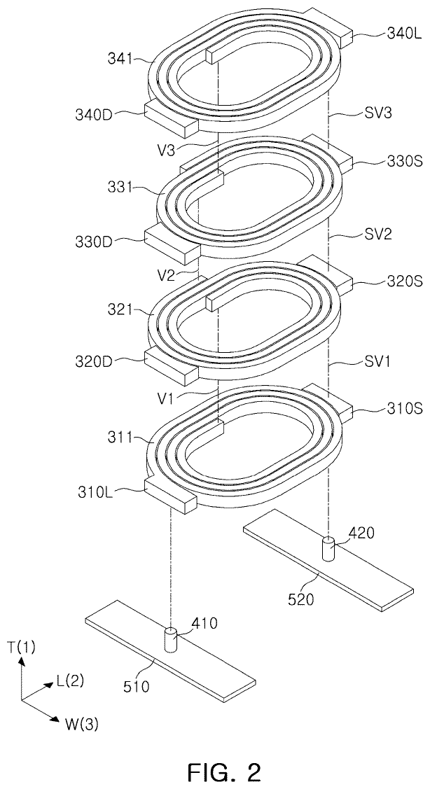

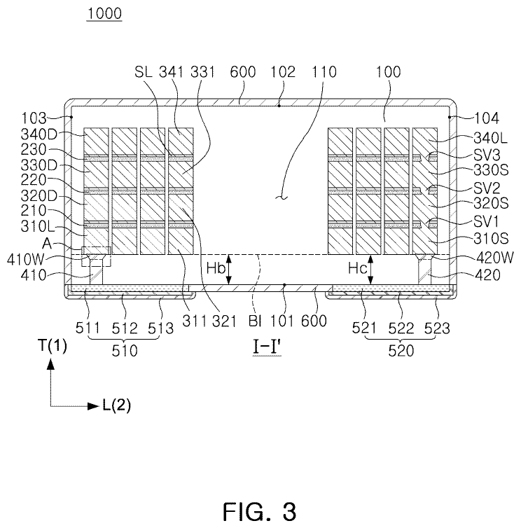

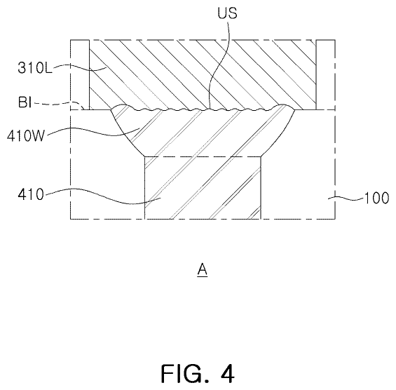

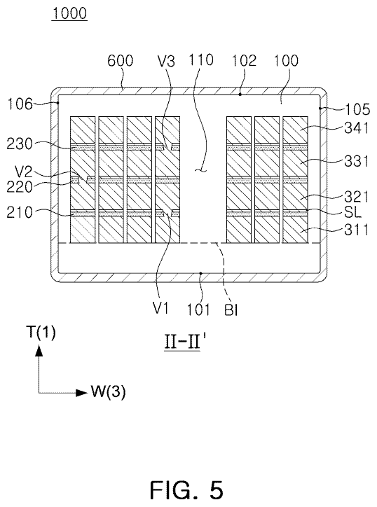

FIG. 1 is a perspective diagram illustrating a coil component according to a first embodiment. FIG. 2 is an exploded perspective diagram illustrating the example illustrated in FIG. 1. FIG. 3 is a cross-sectional diagram taken along line I-I′ in FIG. 1. FIG. 4 is an enlarged diagram illustrating region A in FIG. 3. FIG. 5 is a cross-sectional diagram taken along line II-II′ in FIG. 1.

In FIG. 1, the external insulating layer 600 on the body 100 which may be applied to the embodiment may not be provided to illustrate coupling between components clearly.

The coil component 1000 according to the embodiment may not include a substrate therein, and may include a plurality of coil layers 310, 320, 330, and 340 laminated in order and insulating layers 210, 220, and 230 disposed between coil layers.

According to the coil component 1000 according to the embodiment, inductance capacitance may be improved by increasing the number of turns of a coil by the multilayer coil structure, and a more magnetic material may be disposed in the body 100 by a volume excluding a substrate, and as an effective volume increases, inductance properties and saturation current properties Iₛₐₜ may be improved.

Also, the coil component 1000 according to the embodiment may include connection portions 410 and 420 connecting the coil 300 to the external electrodes 510 and 520 in the body 100, the connection portions 410 and 420 may be formed in advance and may be fused with the coil 300, and a magnetic sheet may be laminated, thereby forming the body 100.

The coil component 1000 according to the embodiment may implement an electrode structure in which the external electrodes 510 and 520 may be disposed on a lower surface of the body 100, that is, the first surface 101, such that as the effective volume of the coil component 1000 increases, inductance properties may be improved and saturation current properties Iₛₐₜ may also be improved.

Also, a process for implementing a lower-surface electrode may be simplified, and as compared to the example in which the connection portions 410 and 420 may be plated from the coil 300 to the external electrodes 510 and 520, a height of the connection portions 410 and 420 may be controlled.

Also, since fusion portions 410W and 420W are formed through welding between the coil 300 and the connection portions 410 and 420, physical bonding force and connection reliability between the coil 300 and the connection portions 410 and 420 may be improved.

In the description below, main components included in the coil component 1000 according to the embodiment will be described in greater detail.

Referring to FIGS. 1 to 5, the coil component 1000 according to the first embodiment may include a body 100, insulating layers 210, 220, and 230, a coil 300, external electrodes 510 and 520, and connection portions 410 and 420 connecting the coil 300 to the external electrodes 510 and 520, respectively.

The body 100 may form an exterior of the coil component 1000 in the embodiment, and the coil 300 may be disposed therein. The coil 300 may be supported by insulating layers 210, 220, and 230.

The body 100 may have a hexahedral shape.

The body 100 may include a first surface 101 and a second surface 102 opposing each other in the thickness direction T, a third surface 103 and a fourth surface 104 opposing each other in the length direction L, and a fifth surface 105 and a sixth surface 106 opposing each other in the width direction W. Each of the first to fourth surfaces 101, 102, 103 and 104 of the body 100 may be a wall surface of the body 100 connecting the third surface 103 and the fourth surface 104 of the body 100.

The body 100 may be formed such that the coil component in which the external electrodes 510 and 520 are formed may have a length of 2.5 mm, a width of 2.0 mm and a thickness of 0.8 mm, may have a length of 2.0 mm, a width of 1.2 mm and a thickness of 0.6 mm, may a length of 1.6 mm, a width of 0.8 mm and a thickness of 0.6 mm, may have a length of 1.6 mm, a width of 0.8 mm and a thickness of 0.4 mm, may have a length of 1.4 mm, a width of 1.2 mm and a thickness of 0.65 mm, may have a length of 1.0 mm, a width of 0.7 mm and a thickness of 0.65 mm, may have a length of 0.8 mm, a width of 0.4 mm and a thickness of 0.65 mm, or may have a length of 0.8 mm, a width of 0.4 mm and a thickness of 0.5 mm, but an embodiment thereof is not limited thereto. As the above-described exemplary dimensions for the length, width and thickness of the coil component 1000 may refer to dimensions not reflecting process errors, dimensions in the range recognized as process errors may correspond to the above-described example dimensions.

The length of the above-described coil component 1000 may be a maximum value among dimensions of a plurality of line segments connecting two outermost boundary lines of the coil component 1000, opposing each other in the length direction L, to each other and in parallel to the length direction L, with respect to an optical microscope image or a scanning electron microscope (SEM) image with respect to a cross-section in the length direction L-thickness direction T taken n from the central portion of the coil component 1000 taken in the width direction W. Alternatively, the length of the coil component 1000 may refer to a minimum value among the dimensions of the plurality of line segments described above. Alternatively, the length of the coil component 1000 may refer to an arithmetic mean value of at least three or more of the dimensions of the plurality of line segments described above. Here, the plurality of line segments parallel to the length direction L may be spaced apart from each other by an equal distance in the thickness direction T, but an embodiment thereof is not limited thereto.

The thickness of the above-described coil component 1000 be a maximum value among dimensions of a plurality of line segments connecting two outermost boundary lines of the coil component 1000, opposing each other in the thickness direction T, to each other and in parallel to the thickness direction T, with respect to an optical microscope image or a scanning electron microscope (SEM) image with respect to a cross-section in the length direction L-thickness direction T taken from the central portion of the coil component 1000 taken in the width direction W. Alternatively, the thickness of the coil component 1000 may refer to a minimum value among the dimensions of the plurality of line segments described above. Alternatively, the thickness of the coil component 1000 may refer to an arithmetic mean value of at least three or more of the dimensions of the plurality of line segments described above. Here, the plurality of line segments parallel to the thickness direction T may be spaced apart from each other by an equal distance in the length direction L, but an embodiment thereof is not limited thereto.

The width of the above-described coil component 1000 may be a maximum value among dimensions of a plurality of line segments connecting two outermost boundary lines of the coil component 1000, opposing each other in the width direction W, to each other and in parallel to the width direction W, with respect to an optical microscope image or a scanning electron microscope (SEM) image with respect to a cross-section in the length direction L-width direction w taken from the central portion of the coil component 1000 taken in the thickness direction T. Alternatively, the width of the coil component 1000 may refer to a minimum value among the dimensions of the plurality of line segments described above. Alternatively, the width of the coil component 1000 may refer to an arithmetic mean value of at least three or more of the dimensions of the plurality of line segments described above. Here, the plurality of line segments parallel to the width direction W may be spaced apart from each other by an equal distance in the length direction L, but an embodiment thereof is not limited thereto.

Alternatively, each of the length, a width and thickness of the coil component 1000 may be measured by a micrometer measurement method. The micrometer measurement method may be of determining a zero point with a gage repeatability and reproducibility (R&R) micrometer, inserting the coil component 1000 in the embodiment between tips of the micrometer, and measuring by turning a measuring lever of a micrometer. In measuring the length of the coil component 1000 by the micrometer measurement method, the length of the coil component 1000 may refer to a value measured once or may refer to an arithmetic average of values measured a plurality of times, which may be equally applied to the width and thickness of the coil component 1000. The body 100 may include a magnetic material and

resin. Specifically, the body 100 may be formed by laminating one or more magnetic composite sheets in which a magnetic material is dispersed in an insulating resin. The magnetic material may be ferrite or metallic magnetic powder.

Ferrite may be at least one of, for example, spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, hexagonal ferrites such as Ba—Zn-based ferrite, Ba—Mg-based ferrite, Ba—Ni-based ferrite, Ba—Co-based ferrite, Ba—Ni—Co-based ferrite, garnet-type ferrites such as Y-based ferrite, and Li-based ferrites.

Metal magnetic powder may include one or more selected from a group consisting of iron (Fe), silicon (Si), chromium (Cr), cobalt (Co), molybdenum (Mo), aluminum (Al), niobium (Nb), copper (Cu) and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr-based alloy powder and Fe—Cr—Al alloy powder.

The metal magnetic powder may be amorphous or crystalline. For example, the magnetic metal powder may be a Fe—Si—B—Cr amorphous alloy powder, but an embodiment thereof is not limited thereto.

Each particle of ferrite and magnetic metal powder may have an average diameter of about 0.1 μm to 30 μm, but an embodiment thereof is not limited thereto.

The body 100 may include two or more types of magnetic materials dispersed in a resin. Here, the different types of magnetic materials may indicate that the magnetic materials dispersed in the resin may be distinguished from each other by one of an average diameter, composition, crystallinity, and shape.

Hereinafter, the description will be made on the premise that the magnetic material is a metal magnetic powder, but the material is not only limited to the body 100, which has a structure in which the metal magnetic powder is dispersed in an insulating resin.

The insulating resin may include epoxy, polyimide, a liquid crystal polymer, or the like, alone or in combination but an embodiment thereof is not limited thereto.

Referring to FIGS. 3 and 5, the body 100 may include a core 110 penetrating the insulating layers 210, 220, and 230 and the coil 300. The core 110 may be disposed in a central region of an innermost turn of the coil 300, that is, in the central region of the winding of the coil 300.

The core 110 may be formed by filling a through-hole penetrating a center of the coil 300 and the center of the insulating layers 210, 220, and 230 with a magnetic composite sheet including a magnetic material, but an embodiment thereof is not limited thereto.

Referring to FIGS. 3 and 5, the coil component 1000 according to the embodiment may include a body interfacial surface BI formed in the body 100 and perpendicular to the first direction T.

With respect to the first surface 101 of the body 100, a height Hb of a body interfacial surface BI may be equal to or smaller than a distance Hc between the first coil layer 310 and the first surface 101 of the body 100.

Here, the height Hb of the body interfacial surface BI may refer to, with respect to an optical microscope image or a scanning electron microscope (SEM) image of an L-T cross-section taken from a center of the coil component 1000 in the third direction W, an arithmetic average of at least three dimensions of dimensions of a plurality of line segments connecting the body interfacial surface BI to the first surface 101 of the body 100 illustrated in the image of the cross-section in the thickness direction T and parallel to the thickness direction T. Here, the plurality of line segments parallel to the thickness direction T may be spaced from each other by an equal distance in the longitudinal direction L, but an embodiment thereof is not limited thereto.

Also, a distance Hc between the first coil layer 310 and the first surface 101 of the body 100 may refer to an arithmetic average of at least three dimensions of dimensions of a plurality of line segments connecting a lower surface of the first coil pattern 311 and the first surface 101 of the body 100 illustrated in the image of the cross-section in the thickness direction T and parallel to the thickness direction T. Here, the plurality of line segments parallel to the thickness direction T may be spaced from each other by an equal distance in the longitudinal direction L, but an embodiment thereof is not limited thereto.

The body interfacial surface BI in the embodiment may be formed in a region between the first coil layer 310 and the first surface 101 of the body 100, and may be due to performing the process of forming the body 100 in two stages. The detailed process order will be described later.

The coil 300 may be disposed in the body 100 and may exhibit properties of the coil component 1000. For example, when the coil component 1000 in the embodiment may be used as a power inductor, the coil 300 may store an electric field as a magnetic field and maintain an output voltage, thereby stabilizing power supply of an electronic device.

The coil 300 of the coil component 1000 according to the embodiment may have a structure of four or more layers and may include first to fourth coil layers 310, 320, 330, and 340 laminated in order. Each of the coil layers 310, 320, 330, and 340 may have at least one turn wound around the core 110.

Referring to FIGS. 1 to 3 and 5, the first coil layer 310 in the embodiment may include a first coil pattern 311 having at least one turn, a first lead-out portion 310L extending from the first coil pattern 311 and being in contact with the first connection portion 410, and a first sub-lead-out portion 310S spaced apart from the first coil pattern 311.

Here, the first lead-out portion 310L may be a component electrically connecting the first coil pattern 311 to the first external electrode 510, and the first sub-lead-out portion 310S may be configured as an electrical connection path between the second lead-out portion 340L and the second external electrode 520.

Also, the second coil layer 320 in the embodiment may further include a second coil pattern 321 disposed on the first coil layer 310 and having at least one turn, and a second sub-lead-out portion 320S spaced apart from the second coil pattern 321, and a first dummy pattern 320D spaced apart from the second coil pattern 321.

Here, the second sub-lead-out portion 320S may be configured as an electrical connection path between the second lead-out portion 340L and the second external electrode 520, and the first dummy pattern 320D may not be relevant to electrical connection.

As the second coil layer 320 includes the first dummy pattern 320D, the shapes of the coil layers 310, 320, 330, and 340 may become similar, thereby increasing the efficiency of a process of forming the coil 300, and the coil 300 may have a symmetrical shape in a region adjacent to the third surface 103 of the body 100 and a region adjacent to the fourth surface 104 of the body 100, thereby preventing exterior defects of the coil component 1000.

Also, the third coil layer 330 in the embodiment may include a third coil pattern 331 disposed on the second coil layer 320 and having at least one turn, and a third sub-lead-out portion 330S spaced apart from the third coil pattern 331, and may further include a second dummy pattern 330D spaced apart from the third coil pattern 331.

Here, the third sub-lead-out portion 330S may be configured as an electrical connection path between the second lead-out portion 340L and the second external electrode 520, and the second dummy pattern 330D may not be relevant to electrical connection.

As the third coil layer 330 includes the second dummy pattern 330D, the shapes of the coil layers 310, 320, 330, and 340 may become similar, thereby increasing the efficiency of the process of forming the coil 300, and the coil 300 may have a symmetrical shape in a region adjacent to the third surface 103 of the body 100 and a region adjacent to the fourth surface 104 of the body 100, thereby preventing exterior defects of the coil component 1000.

Also, the fourth coil layer 340 in the embodiment may include a fourth coil pattern 341 having at least one turn, a second lead-out portion 340L extending from the fourth coil pattern 341 and electrically connected to the second external electrode 520, and may further include a third dummy pattern 340D spaced apart from the fourth coil pattern 341.

Here, the second lead-out portion 340L may be electrically connected to the second external electrode 520 through sub-via SV1, SV2, and SV3, sub-lead-out portion 310S, 320S, and 330S, and second connection portion 420, and the third dummy pattern 340D may not be relevant to electrical connection.

As the fourth coil layer 340 includes the third dummy pattern 340D, the shapes of the coil layers 310, 320, 330, and 340 may become similar, thereby increasing the efficiency of the process of forming the coil 300, and the coil 300 may have a symmetrical shape in a region adjacent to the third surface 103 of the body 100 and a region adjacent to the fourth surface 104 of the body 100, thereby preventing exterior defects of the coil component 1000.

Referring to FIGS. 2 and 5, the coil layers 310, 320, 330, and 340 in the embodiment may be connected to each other through vias V1, V2, and V3.

Specifically, the coil 300 in the embodiment may include a first via V1 connecting internal ends of the first and second coil patterns 311 and 321 to each other, a second via V2 connecting external ends of the second and third coil patterns 321 and 331 to each other, and a third via V3 connecting internal ends of the third and fourth coil patterns 331 and 341 to each other.

With respect to the direction in FIG. 5, a lower surface of the first via V1 may be connected to an end of an innermost turn of the first coil pattern 311, and an upper surface of the first via V1 may be connected to an end of an innermost turn of the second coil pattern 321. The first via V1 may penetrate the first insulating layer 210, and when the first via V1 is formed by irradiating a laser downwardly, a lower surface may have a tapered shape having a relatively narrow width.

Also, a lower surface of the second via V2 may be connected to an end of an outermost turn of the second coil pattern 321, and an upper surface of the second via V2 may be connected to an end of an outermost turn of the third coil pattern 331. The second via V2 may penetrate the second insulating layer 220, and when the second via V2 is formed by irradiating a laser downwardly, a lower surface may have a tapered shape having a relatively narrow width.

Also, a lower surface of the third via V3 may be connected to an end of an innermost turn of the third coil pattern 331, and an upper surface of the third via V3 may be connected to an end of an innermost turn of the fourth coil pattern 341. The third via V3 may penetrate the third insulating layer 230, and when the third via V3 is formed by irradiating a laser downwardly, a lower surface may have a tapered shape having a relatively narrow width.

Referring to FIGS. 2 and 3, the second lead-out portion 340L and the sub-lead-out portions 310S, 320S, and 330S in the embodiment may be connected to each other through the sub-vias SV1, SV2, and SV3.

Specifically, the coil 300 in the embodiment may include the first sub-via SV1 connecting the first and second sub-lead-out portions 310S and 320S to each other, a second sub-via SV2 connecting the second and third sub-lead-out portion 320S and 330S to each other, and a third sub-via connecting the third sub-lead-out portion 330S to the second lead-out portion 340L.

With respect to the direction in FIG. 3, a lower surface of the first sub-via SV1 may be connected to the first sub-lead-out portion 310S, and an upper surface of the first sub-via SV1 may be connected to the second sub-lead-out portion 320S. The first sub-via SV1 may penetrate the first insulating layer 210, and when the first sub-via SV1 is formed by irradiating a laser downwardly, a lower surface may have a tapered shape having a relatively narrow width.

Also, a lower surface of the second sub-via SV2 may be connected to the second sub-lead-out portion 320S, and an upper surface of the second sub-via SV2 may be connected to the third sub-lead-out portion 330S. The second sub-via SV2 may penetrate the second insulating layer 220, and when the second sub-via SV2 is formed by irradiating a laser downwardly, the lower surface may have a tapered shape having a relatively narrow width.

Also, a lower surface of the third sub-via SV3 may be connected to the third sub-lead-out portion 330S, and an upper surface of the third sub-via SV3 may be connected to the second lead-out portion 340L. The third sub-via SV3 may penetrate the third insulating layer 230, and when the third sub-via SV3 is formed by irradiating a laser downwardly, the lower surface may have a tapered shape having a relatively narrow width.

However, the shape of each of the first to third via V1, V2, and V3 and the first to third sub-via SV1, SV2, and SV3 is not limited to a tapered shape having a relatively narrow lower surface, and depending on a thickness of the insulating layers 210, 220, and 230 and laser intensity, the cross-sectional area thereof may have a constant shape.

Referring to FIG. 2, for example, when the coil component 1000 is mounted on a circuit board and a signal is input to the first external electrode 510, the input signal may be applied to the coil 300 through the first connection portion 410, and may be output to the second external electrode 520 through the second connection portion 420.

More specifically, the signal input to the first external electrode 510 may be output to the second external electrode 520 by passing through the first connection portion 410, the first lead-out portion 310L, the first coil pattern 311, the first via V1, the second coil pattern 321, the second via V2, the third coil pattern 331, the third via V3, the fourth coil pattern 341, the second lead-out portion 340L, the third sub-via SV3, the third sub-lead-out portion 330S, the second sub-via SV2, the second sub-lead-out portion 320S, the first sub-via SV1, the first sub-lead-out portion 310S, and the second connection portion 420 in order.

Accordingly, the coil 300 may function as a coil between the first and second connection portions 410 and 420.

Referring to FIGS. 3 and 5, each of the second to fourth coil layers 320, 330, and 340 may include a seed layer SL. That is, the first coil layer 310 in the embodiment may not include the seed layer SL, which may be related to the process described later, and the first coil layer 310 may be formed on the copper clad laminate (CCL), and the copper clad laminate (CCL) may be removed after the second to fourth coil layers 320, 330, and 340 are formed in order, such that the first coil layer 310 may not include a seed layer SL, but an embodiment thereof is not limited thereto.

A side surface of the seed layer SL in the embodiment may be in contact with the body 100. In other words, both side surfaces of the seed layer SL may be exposed toward the internal region of the body 100, and both side surfaces of the seed layer SL may not be covered by the plating layers other than the seed layer SL in each of the second to fourth coil layers 320, 330, and 340.

At least one of the coil patterns 311, 321, 331, and 341, the vias V1, V2, and V3, the lead-out portions 310L and 340L, the sub-lead-out portions 310S, 320S, and 330S, the sub-vias SV1, SV2, and SV3, and the dummy patterns 320D, 330D, and 340D may include at least one conductive layer.

As an example, when the second coil pattern 321, the second via V2, the second sub-lead-out portion 320S, the second sub-via SV2, and the first dummy pattern 320D are formed by plating, each of the second coil pattern 321, the second via V2, the second sub-lead-out portion 320S, the second sub-via SV2, and the first dummy pattern 320D may include the seed layer SL and an electroplating layer.

Here, the electroplating layer may have a single-layer structure or a multilayer structure. The electroplating layer having a multilayer structure may be formed as a conformal film structure in which one electroplating layer is covered by another electroplating layer, or may be formed in a shape in which another electroplating layer is laminated on only one surface of one electroplating layer. The seed layer SL may be formed by electroless plating or vapor deposition methods such as sputtering.

The seed layer SL of each of the second coil pattern 321, the second via V2, the second sub-lead-out portion 320S, the second sub-via SV2, and the first dummy pattern 320D may be formed integrally, such that no boundary may be formed therebetween, but an embodiment thereof is not limited thereto. The electroplating layer of each of the second coil pattern 321, the second via V2, the second sub-lead-out portion 320S, the second sub-via SV2, and the first dummy pattern 320D may be formed integrally, such that a boundary may not be formed therebetween, but an embodiment thereof is not limited thereto.

The coil patterns 311, 321, 331, and 341, the vias V1, V2, and V3, the lead-out portions 310L and 340L, the sub-lead-out portions 310S, 320S, and 330S, the sub-vias SV1, SV2, and SV3, and the dummy patterns 320D, 330D, and 340D may be formed of a conductive material such as copper (Cu), aluminum (Al), silver (Ag), tin (Sn), gold (Au), nickel (Ni), lead (Pb), chromium (Cr), titanium (Ti), or alloys thereof, but an embodiment thereof is not limited thereto.

Referring to FIGS. 3 and 5, the coil component 1000 according to the embodiment may include insulating layers 210, 220, and 230 disposed in regions between the first and fourth coil layers 310, 320, 330, and 340, respectively.

The insulating layers 210, 220, and 230 may be configured to insulate the coil layers 310, 320, 330, and 340 from each other.

Specifically, the insulating layers 210, 220, and 230 may include a first insulating layer 210 disposed between the first and second coil layers 310 and 320, a second insulating layer 220 disposed between the second and third coil layers 320 and 330, and a third insulating layer 230 disposed between the third and fourth coil layers 330 and 340.

The seed layer SL may be disposed on the insulating layers 210, 220, and 230, and the insulating layers 210, 220, and 230 may be penetrated by the via V1, V2, and V3 or the sub-via SV1, SV2, and SV3.

The insulating layers 210, 220, and 230 may be formed of a thermosetting insulating resin such as an epoxy resin, a thermoplastic insulating resin such as polyimide, or an insulating material including a photosensitive insulating resin, or an insulating material in which the insulating resin is impregnated with a reinforcing material.

For example, the insulating layers 210, 220, and 230 may be formed of a film-type insulating material such as prepreg, Ajinomoto build-up film (ABF), and photo imaginable dielectric (PID) film, but an embodiment thereof is not limited thereto. The insulating layers 210, 220, and 230 may be formed by applying a liquid insulating resin and curing the resin.

As another example, the insulating layers 210, 220, and 230 may include a generally used insulating material such as paralene, and may be formed by a method such as vapor deposition.

Referring to FIGS. 1 to 4, the coil component 1000 according to the embodiment may include connection portions 410 and 420 connecting the first and second external electrodes 510 and 520 to the coil 300, respectively.

The connection portions 410 and 420 may be disposed in the body 100 and may be configured to electrically connect the coil 300 to the external electrodes 510 and 520. As compared to an L-shaped electrode disposed on the third surface 103 and the fourth surface 104 of the body 100 and extending to the first surface 101, a path through which a current flows between the external electrodes 510 and 520 of the first surface 101 of the body 100 and the coil 300 is shortened, such that direct current resistance component R_{dc} may be reduced.

The connection portions 410 and 420 may include one surface in contact with the first coil layer 300 and the other surface in contact with the external electrodes 510 and 520.

Also, the connection portions 410 and 420 may include a side surface connecting the one surface to the other surface and may have a cylindrical shape. However, an embodiment thereof is not limited thereto, and the connection portions 410 and 420 may have various shapes, such as a tapered shape of which a cross-sectional area is widened downwardly, a tapered shape of which a cross-sectional area is narrowed downwardly, or an angular pillar shape.

The connection portions 410 and 420 in the embodiment may be formed by electroplating and may include a conductive material such as copper (Cu), aluminum (Al), silver (Ag), tin (Sn), gold (Au), nickel (Ni), lead (Pb), chromium (Cr), titanium (Ti), or alloys thereof, but an embodiment thereof is not limited thereto.

In the coil component 1000 according to the embodiment, the connection portions 410 and 420 connecting the external electrodes 510 and 520 in the first direction T may be formed separately from the coil 300, and the first coil layer 310 and the connection portions 410 and 420 may be fused to each other.

Accordingly, the connection portions 410 and 420 in the embodiment may include fusion portions 410W and 420W formed on ends in contact with the first coil layer 310. Here, the fusion portions 410W and 420W may correspond to regions formed by fusion between the connection portions 410 and 420 and the first coil layer 310 by resistance welding, laser welding, or ultrasonic welding. For ease of description, a boundary line may be indicted in the connection portions 410 and 420 as a configuration line.

Referring to FIG. 3, the first connection portion 410 may connect the first external electrode 510 to the first lead-out portion 310L in the body 100, and the first connection portion 410 may include a first fusion portion 410W formed on an end in contact with the first lead-out portion 310L.

Also, the second connection portion 420 may connect the second external electrode 520 to the first sub-lead-out portion 310S in the body 100, and the second connection portion 420 may include a second fusion portion 420W formed on an end in contact with the first sub-lead-out portion 310S.

The fusion portions 410W and 420W in the embodiment may have a partially deformed shape due to heat and pressure when fused with the first coil layer 310 by resistance welding, laser welding, or ultrasonic welding.

FIG. 4 is an enlarged diagram illustrating region A in FIG. 3.

Referring to FIGS. 3 and 4, the first connection portion 410 may include a first fusion portion 410W formed in a region in contact with the first lead-out portion 310L, and at least a portion of the first fusion portion 410W may be recessed into the first lead-out portion 310L.

Similarly, the second connection portion 420 may include a second fusion portion 420W formed in a region in contact with the first sub-lead-out portion 310S, and at least a portion of the second fusion portion 420W may be recessed into the first sub-lead-out portion 310S.

For example, when the fusion portions 410W and 420W and the lead-out portions 331 and 332 are fused to each other through resistance welding, at least a portion of the fusion portions 410W and 420W may be recessed into the lead-out portions 331 and 332 due to heat generated according to a current flow and pressure in the first direction T.

Referring to FIG. 4, the first fusion portion 410W may have a shape in which a portion of an upper surface is widened by pressure in the first direction T, and accordingly, at least a portion thereof may protrude toward the body 100.

Similarly, the second fusion portion 420W may also have a shape of which at least a portion protrudes toward the body 100.

Accordingly, with respect to an optical microscope image or a scanning electron microscope (SEM) image of an L-T cross-section taken from a center of the coil component 1000 in the third direction W, at least a portion of the fusion portions 410W and 420W may protrude toward the body 100 in the second direction L.

For example, when the fusion portions 410W and 420W and the first coil layer 310 are fused to each other through resistance welding, at least a portion of the fusion portions 410W and 420W may protrude toward the body 100 due to heat generated according to a current flow and pressure in the first direction T.

Referring to FIGS. 3 and 4, an interfacial surface may be formed between the fusion portions 410W and 420W and the first coil layer 310. Specifically, an interfacial surface may be formed between the first fusion portion 410W and the first lead-out portion 310L, and an interfacial surface may be formed between the second fusion portion 420W and the first sub-lead-out portion 310S.

Traces of changes in a crystal structure due to metal particles being melted by heat may be observed on the interfacial surface between the fusion portions 410W and 420W and the first coil layer 310.

Also, an unevenness US may be included in the interfacial surface between the fusion portions 410W and 420W and the first coil layer 310 in the embodiment.

Referring to FIG. 4, the interfacial surface on which the first fusion portion 410W is in contact with the first lead-out portion 310L may include an irregular unevenness US. For example, when the first fusion portion 410W and the first lead-out portion 310L are fused to each other through resistance welding, heat generated due to a current flow and pressure in the first direction T may form the irregular unevenness US on the interfacial surface between the first fusion portion 410W and the first lead-out portion 310L. On the other hand, another portion of the surface of the first lead-out portion 310L, which is not in contact with the first fusion portion 410W and surrounds the interfacial surface with the first fusion portion 410W, may not have the irregular unevenness US. Even if another portion of the surface of the first lead-out portion 310L, which is not in contact with the first fusion portion 410W and surrounds the interfacial surface with the first fusion portion 410W, may have some irregular unevenness, a degree of such irregular unevenness may be smaller than a degree of the irregular unevenness US.

In the coil component 1000 according to the embodiment, a contact area may increase due to the unevenness US between the fusion portions 410W and 420W and the first coil layer 310, such that physical bonding force and electrical connection reliability may be increased, and direct current resistance component Rac may also be reduced.

Referring to FIGS. 1 to 3, the first and second external electrodes 510 and 520 may be spaced apart from each other on the first surface 101 of the body 100 and may be connected to the coil 300 through the first and second connection portions 410 and 420, respectively.

Referring to FIG. 3, the external electrodes 510 and 520 may be formed in a multilayer structure.

As an example, the external electrodes 510 and 520 may include first layers 511 and 521 disposed on the body 100, and second layers 512 and 522 disposed on the first layers 511 and 521, and may further include third layers 513 and 523 disposed on the second layers 512 and 522.

At least one of the second layers 512 and 522 and the third layers 513 and 523 may be formed in a shape covering the first layers 511 and 521, but an embodiment thereof is not limited thereto.

The first layer 511 and 521 may be a copper (Cu) plating layer or a conductive resin layer including conductive powder including at least one of copper (Cu) and silver (Ag) and an insulating resin.

The second layers 512 and 522 may be plating layers including nickel (Ni), and the third layers 513 and 523 may be plating layers including tin (Sn), but an embodiment thereof is not limited thereto, and the second layers 512 and 522 and the third layers 513 and 523 may be integrally formed in an alloy shape of nickel (Ni) and tin (Sn).

The first and second external electrodes 510 and 520 may be formed by a vapor deposition method such as sputtering and/or a plating method, but an embodiment thereof is not limited thereto.

The first and second external electrode 510 and 520 may be formed of a conductive material such as copper (Cu), aluminum (Al), silver (Ag), tin (Sn), gold (Au), nickel (Ni), lead (Pb), chromium (Cr), titanium (Ti), or alloys thereof, but an embodiment thereof is not limited thereto.

Referring to FIGS. 3 and 5, the coil component 1000 according to the embodiment may further include an external insulating layer 600 covering the surface of the body 100 and exposing the external electrodes 510 and 520.

Specifically, the external insulating layer 600 in the embodiment may cover at least a portion of the first surface 101 of the body 100 and may expose the first and second external electrodes 510 and 520, and may extend to cover at least a portion of the second surface to the sixth surface 102, 103, 104, 105, and 106 of the body 100.

In the embodiment, each of the external insulating layers 600 disposed on the first surface to the sixth surface 101, 102, 103, 104, 105, and 106 of the body 100 may be disposed in the same process and may have a shape without boundaries therebetween, but an embodiment thereof is not limited thereto, and the external insulating layers 600 may be formed in different processes and a boundary may be formed between the external insulating layers 600 on each surface.

The external insulating layer 600 may be formed by a printing method, a vapor deposition method, a spray coating method, or a film laminate method, but an embodiment thereof is not limited thereto.

The external insulating layer 600 may include thermoplastic resins such as polystyrene resin, vinyl acetate resin, polyester resin, polyethylene resin, polypropylene resin, polyamide resin, rubber resin, and acrylic resin, thermosetting resins such as phenolic resin, epoxy resin, urethane resin, melamine resin, alkyd resin, or the like, photosensitive resin, paralyne, SiOₓ or SiNₓ. The external insulating layer 600 may further include an insulating filler such as an inorganic filler, but an embodiment thereof is not limited thereto.

### Second Embodiment

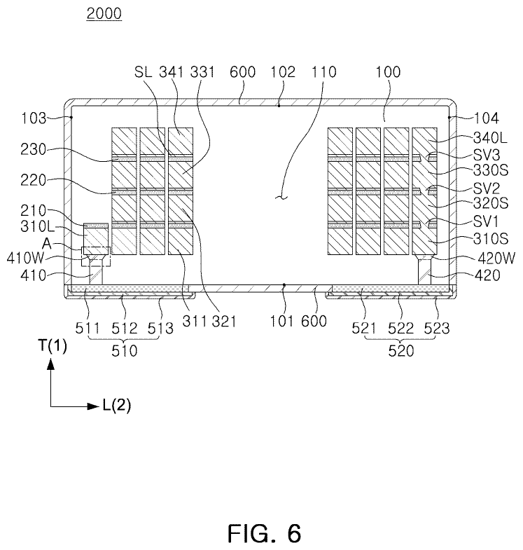

FIG. 6 is a diagram illustrating a coil component according to a second embodiment, corresponding to FIG. 3.

Comparing FIG. 6 with FIG. 3, the configuration in which dummy patterns 320D, 330D, and 340D are not included in the second to fourth coil layers 320, 330, and 340, respectively, and a configuration in which the body 100 is formed integrally and the body interfacial surface BI is not formed may be different. That is, referring to FIG. 6, the coil 300 may have asymmetric shape as the coil 300 may be different in the region adjacent to the third surface 103 of the body 100 and the region adjacent to the fourth surface 104 of the body 100, and the internal region of the body 100 may be formed integrally without the body interfacial surface BI.

Accordingly, in describing the embodiment, only the third surface 103 of the body 100, the shape of the adjacent coil 300, and the body 100, which are different from the first embodiment, will be described. The description in the first embodiment may be applied to the other components in the embodiment.

Referring to FIG. 6, only the first lead-out portion 310L of the first coil layer 310 may be disposed in the region of the coil 300 adjacent to the third surface 103 of the body 100, and the dummy patterns 320D, 330D, and 340D may not be disposed on the second to fourth coil layers 320, 330, and 340, respectively.

Accordingly, the shape of each of the second to fourth coil layers 320, 330, and 340 may be formed differently from the shape of the first coil layer 310.

In the coil component 2000 according to the embodiment, the dummy patterns 320D, 330D, and 340D not affecting electrical connection may be removed, such that the magnetic material arrangement space equivalent to the volume occupied by the dummy pattern 320D, 330D, and 340D may be ensured, and accordingly, the effective volume may increase, such that the effect of improvement of inductance may be increased.

FIG. 6 illustrates a structure in which the dummy patterns 320D, 330D, and 340D of the second coil layer 320, the third coil layer 330, and the fourth coil layer 340 are removed, but an embodiment thereof is not limited thereto, and at least one of the second coil layer 320, the third coil layer 330, and the fourth coil layer 340 of the dummy patterns 320D, 330D, and 340D may be removed and the other components may remain.

For example, the dummy pattern 320D of the second coil layer 320 may remain, and only the dummy patterns 330D and 340D of the third and fourth coil layers 330 and 340 may be removed.

Also, referring to FIG. 6, the body interfacial surface BI may not be formed in the body 100 in the embodiment, which may be because the forming of the body 100 through magnetic sheet laminate may be performed in a single process, such that in the embodiment, the process stage may be shortened and production efficiency may be increased.

### Process of Manufacturing Coil Component According to First Embodiment

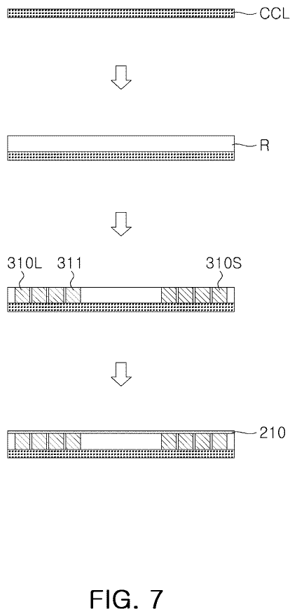

FIGS. 7 to 10 are a diagram illustrating a process of manufacturing a coil component according to a first embodiment.

Referring to FIG. 7, a first copper clad laminate (CCL) for forming a first coil layer 310 may be prepared. In the copper clad laminate (CCL), a copper clad may be attached to both surfaces or one surface of an insulator such as glass fiber (FR-4). In the embodiment, it may be sufficient that a copper clad may be attached only to the one surface on which the first coil layer 310 is disposed.

Thereafter, plating resist R may be disposed on one surface of the copper clad laminate (CCL). The plating resist R may be formed of a material including a photosensitive organic material or a photosensitive resin, and may be a generally used DFR film, but an embodiment thereof is not limited thereto.

Thereafter, the plating resist R may be patterned through exposure and development, and the first coil layer 310 may be formed through electrolytic plating.

Thereafter, the first insulating layer 210 may be disposed integrally on the first coil layer 310 and the plating resist R. In this case, by performing mechanical or chemical processing on the upper surface of the first coil layer 310, a height of the upper surface of the first coil layer 310 may be implemented the same as a height of the upper surface of the plating resist R.

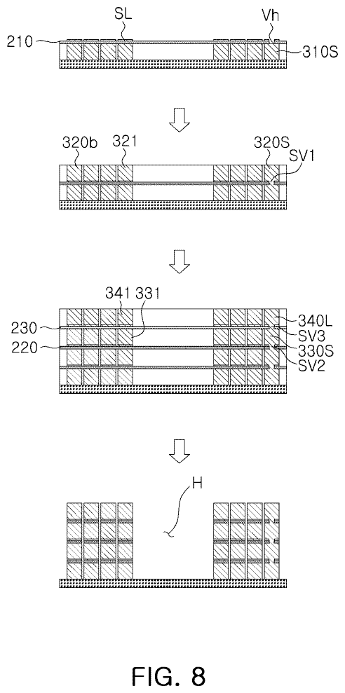

Thereafter, referring to FIG. 8, the seed layer SL may be patterned according to a shape of the second coil layer 320 on the first insulating layer 210, and a via hole Vh penetrating the first insulating layer 210 may be formed in a position in which the first sub-via SV1 is disposed.

In the embodiment, the seed layer SL may be disposed only on the upper surface of the via hole Vh, but that embodiment is not limited thereto, and depending on the process order, the seed layer SL may extend to the side surface of the via hole Vh.

Thereafter, similarly to the process of forming the first coil layer 310, after plating resist R is disposed, the second coil layer 320 may be formed through patterning and electrolytic plating. In this case, the first sub-via SV1 may be formed in the via hole Vh, such that the first sub-lead-out portion 310S of the first coil layer 310 and the second sub-lead-out portion 320S of the second coil layer 320 may be connected to each other.

Thereafter, the second insulating layer 220, the third coil layer 330, the third insulating layer 230, and the fourth coil layer 340 may be laminated in order by repeatedly performing the above-described processes. In this case, the second sub-lead-out portion 320S of the second coil layer 320 and the third sub-lead-out portion 330S of the third coil layer 330 may be connected to each other by the second sub-via SV2, and the third sub-lead-out portion 330S of the third coil layer 330 and the second lead-out portion 340L of the fourth coil layer 340 may be connected to each other by the third sub-via SV3.

Thereafter, a portion of regions of the plating resist R and the insulating layers 210, 220, and 230 may be removed through a cavity process. Accordingly, a through-hole H in which the magnetic material is disposed may be formed in the central portion of the coil 300, and a spacing may be formed between adjacent turns of the coil patterns 311, 321, 331, and 341.

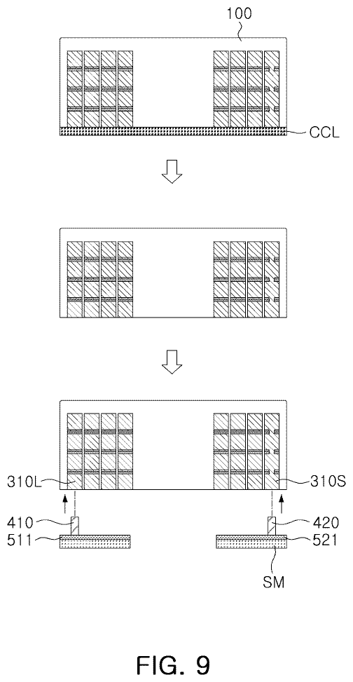

Thereafter, referring to FIG. 9, a portion of the body 100 may be formed by laminating and curing a magnetic sheet with the coil 300 disposed on the copper clad laminate (CCL).

Thereafter, the lower surface of the first coil layer 310 may be exposed by removing the copper clad laminate (CCL) disposed on the lower portion of the body 100. In particular, the lower surface of the first lead-out portion 310L and the lower surface of the first sub-lead-out portion 310S may be exposed.

Thereafter, separately from the coil 300, the first layers 511 and 521 and connection portions 410 and 420 of the external electrodes 510 and 520 may be formed through electrolytic plating on the upper surface of the support member SM. The first layers 511 and 521 of the external electrodes 510 and 520 and the connection portions 410 and 420 may include copper (Cu), but an embodiment thereof is not limited thereto.

The separately formed connection portions 410 and 420 may be coupled to the first lead-out portion 310L and the first sub-lead-out portion 310S exposed to the lower surface of the body 100.

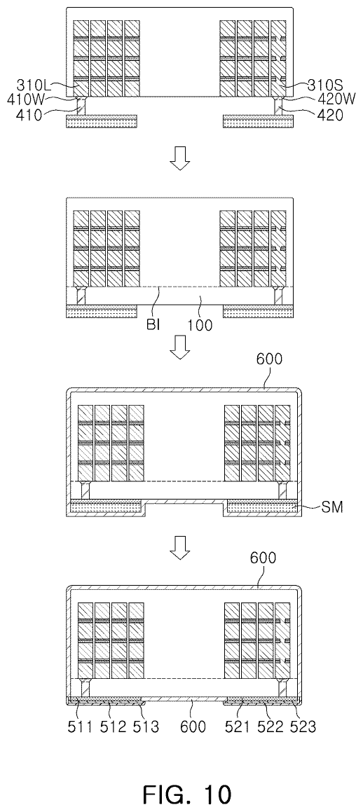

Referring to FIG. 10, the first lead-out portion 310L and the first connection portion 410, and the first sub-lead-out portion 310S and the second connection portion 420 may be fused to each other using resistance welding, laser welding, or ultrasonic welding.

A first fusion portion 410W of which a shape may be partially deformed by heat and pressure may be formed in an upper end region of the first connection portion 410 in contact with the first lead-out portion 310L. Similarly, a second fusion portion 420W of which a shape may be partially deformed by heat and pressure may be formed in an upper end region of the second connection portion 420 in contact with the first sub-lead-out portion 310S.

Thereafter, the body 100 disposed below the first coil layer 310 may be formed by laminating a magnetic material sheet. In this case, a body interfacial surface BI may be formed between the body 100 regions formed in a different process, but an embodiment thereof is not limited thereto. When the body interfacial surface BI is formed, a height of the body interfacial surface BI may be formed to be less than a distance between the first coil layer 310 and a lower surface of the body 100.

Thereafter, the external insulating layer 600 integrally covering the body 100, the first layers 511 and 521 of the external electrodes 510 and 520, and the support member SM may be disposed, which may be advantageous in terms of process efficiency as compared to disposing the external insulating layer 600 by region in a divided manner.

Finally, the support member SM may be removed along with the external insulating layer 600 disposed on the support member SM, and the second layers 512 and 522 and the third layers 513 and 523 may be disposed in order on the first layers 511 and 521 of the exposed external electrodes 510 and 520 through electrolytic plating, thereby implementing the coil component 1000 according to the first embodiment.

According to the aforementioned embodiments, the number of turns of a coil may be increased within a limited size through a multilayer coil structure from which the support substrate is removed.

According to another aspect, inductance properties and saturation current Iₛₐₜ properties may be improved by increasing the effective volume within a coil component having a limited size through a structure in which a coil and an external electrode are connected to each other in the body.

While the embodiments have been illustrated and described above, it will be apparent to those skilled in the art that modifications and variations could be made without departing from the scope of the present disclosure as defined by the appended claims.

What is claimed is:

1. A coil component, comprising:
a body including a first surface and a second surface opposing each other in a first direction;
a coil disposed in the body and including a plurality of coil layers;
an insulating layer disposed in each of regions between the plurality of coil layers;
an external electrode disposed on the first surface of the body; and
a connection portion disposed in the body, connecting one of the plurality of coil layers to the external electrode, and having one surface in contact with the one of the plurality of coil layers and the other surface in contact with the external electrode,
wherein the connection portion includes a fusion portion disposed on an end thereof to be in contact with the one of the plurality of coil layers.

2. The coil component of claim 1, wherein the plurality of coil layers include first to fourth coil layers laminated in order,
wherein the first coil layer is the one of the plurality of coil layers, and
wherein the insulating layer includes a first insulating layer disposed between the first and second coil layers, a second insulating layer disposed between the second and third coil layers, and a third insulating layer disposed between the third and fourth coil layers.

3. The coil component of claim 2, wherein the first coil layer includes a first coil pattern having at least one turn, a first lead-out portion extending from the first coil pattern and being in contact with the connection portion, and a first sub-lead-out portion spaced apart from the first coil pattern.

4. The coil component of claim 3,
wherein the external electrode includes first and second external electrodes connected to the first coil layer and spaced apart from each other, and
wherein the connection portion includes a first connection portion connecting the first lead-out portion to the first external electrode, and a second connection portion connecting the first sub-lead-out portion to the second external electrode.

5. The coil component of claim 3, wherein the second coil layer includes a second coil pattern disposed on the first coil layer and having at least one turn, and a second sub-lead-out portion spaced apart from the second coil pattern.

6. The coil component of claim 5, wherein the second coil layer further includes a first dummy pattern spaced apart from the second coil pattern.

7. The coil component of claim 5, wherein the third coil layer includes a third coil pattern disposed on the second coil layer and having at least one turn, and a third sub-lead-out portion spaced apart from the third coil pattern.

8. The coil component of claim 7, wherein the third coil layer further includes a second dummy pattern spaced apart from the third coil pattern.

9. The coil component of claim 7, wherein the fourth coil layer includes a fourth coil pattern disposed on the third coil layer and having at least one turn, and a second lead-out portion extending from the fourth coil pattern.

10. The coil component of claim 9, wherein the fourth coil layer further includes a third dummy pattern spaced apart from the fourth coil pattern.

11. The coil component of claim 9, wherein the coil further includes a first via connecting internal ends of the first and second coil patterns to each other, a second via connecting external ends of the second and third coil patterns to each other, and a third via connecting internal ends of the third and fourth coil patterns to each other.

12. The coil component of claim 11, wherein the first to third via penetrate the first to third insulating layer, respectively.

13. The coil component of claim 9, wherein the coil further includes a first sub-via connecting the first and second sub-lead-out portions to each other, a second sub-via connecting the second and third sub-lead-out portions to each other, and a third sub-via connecting the third sub-lead-out portion and the second lead-out portion to each other.

14. The coil component of claim 13, wherein the first to third sub-via penetrates the first to third insulating layer, respectively.

15. The coil component of claim 1,
wherein each of coil layers other than the one of the plurality of coil layers among the plurality of coil layers includes a seed layer, and
wherein a side surface of the seed layer is in contact with the body.

16. The coil component of claim 1, wherein at least a portion of the fusion portion is recessed inwardly into the one of the plurality of coil layers.

17. The coil component of claim 1, wherein at least a portion of the fusion portion protrudes toward the body.

18. The coil component of claim 1, wherein the fusion portion and the one of the plurality of coil layers have an interfacial surface.

19. The coil component of claim 18, wherein the interfacial surface includes unevenness.

20. The coil component of claim 1, wherein the body includes a body interfacial surface perpendicular to the first direction.

21. The coil component of claim 20, wherein a height of the body interfacial surface with respect to the first surface is equal to or smaller than a distance between the one of plurality of coil layers and the first surface.

22. The coil component of claim 1, wherein the external electrode includes a first layer disposed on the body, and a second layer disposed on the first layer.

23. The coil component of claim 22, wherein the external electrode further includes a third layer disposed on the second layer.

24. The coil component of claim 1, further comprising:
an external insulating layer covering a surface of the body and exposing the external electrode.
